(19) United States
(12) Patent Application Publication
(10) Pub. No.: US 2019/0168327 A1
(43) Pub. Date: Jun. 6, 2019

(54) METHOD FOR PRODUCING TURBINE BLADE

(71) Applicant: Mitsubishi Hitachi Power Systems, Ltd., Kanagawa (JP)

(72) Inventors: Daisuke YOSHIDA, Kanagawa (JP); Kazuto NISHIZAWA, Kanagawa (JP); Masaki TANEIKE, Tokyo (JP); Ichiro NAGANO, Kanagawa (JP); Naotoshi OKAYA, Kanagawa (JP); Yoshiyuki INOUE, Kanagawa (JP); Hisataka KAWAI, Osaka (JP); Hisashi KITAGAKI, Osaka (JP)

(21) Appl. No.: 16/321,276

(22) PCT Filed: Oct. 5, 2017
(86) PCT No.: PCT/JP2017/036267

§ 371 Date: Jan. 28, 2019

(30) Foreign Application Priority Data
Oct. 7, 2016 (JP) 2016-198776

(51) Int. Cl. B23K 1/00; F01D 5/28; C22C 19/05; C22F 1/10

(52) U.S. Cl. CPC B23K 1/0018; F01D 5/286; B23K 2101/001; C22C 19/056; C22F 1/10; F01D 5/288

(57) ABSTRACT

A method for producing a turbine blade includes performing brazing treatment, performing annealing, and subjecting a base material to solutionizing treatment. In the brazing treatment, a brazing material is welded to be joined to the base material of a turbine blade by operating a heater to perform heating at a first temperature under a state in which the base material having the brazing material arranged thereon is placed in a predetermined heating furnace including the heater. In annealing, the base material is cooled by stopping the heater and lowering a furnace internal temperature after the brazing treatment. In the solutionizing treatment, ductility of the base material is improved through heating at a second temperature lower than the first temperature after the annealing.

### TECHNICAL FIELD

The present invention relates to a method for producing a turbine blade.

### BACKGROUND ART

A gas turbine includes a compressor, a combustor, and a turbine. The compressor takes in and compresses air to produce a high-temperature and high-pressure compressed air. The combustor burns the compressed air by supplying fuel to the compressed air. As the turbine in a vehicle cabin, a plurality of stator blades and rotor blades are alternately arranged. In the turbine, the rotor blades are rotated by a high-temperature and high-pressure combustion gas generated from the compressed air. With the rotation, thermal energy is converted into rotational energy.

The turbine blades such as the stator blades and the rotor blades are exposed in a high temperature environment, and thus are formed of metallic materials having a high heat-resisting property. In a case where the turbine blade is produced, as described in, for example, Patent Document 1, after a base material is formed through casting, forging, and the like, the base material is subjected to predetermined heating treatment (for example, see Patent Document 1). Further, in a case where the base material is subjected to brazing treatment, that is, treatment for welding a brazing material to be joined to the base material by heating the base material having the brazing material arranged thereon, after the brazing treatment, the base material is cooled, and then the base material is subjected to the predetermined heating treatment (for example, see Patent Document 2).

### CITATION LIST

### Patent Document

Patent Document 1: JP 2003-34853 A

Patent Document 2: JP 2002-103031 A

### SUMMARY OF INVENTION

### Problem to be Solved by the Invention

In the producing method described in Patent Document 2, after the brazing treatment, a cooling air is supplied to the base material so that a temperature of the base material is rapidly lowered to a predetermined cooling temperature (quenching). However, a void and the like may be formed in a brazing portion in some cases due to rapid solidification shrinkage of the brazing material caused by the quenching.

The present invention has been made in view of the above, and has an object to provide a method for producing a turbine blade, which is capable of improving quality of a brazing portion.

### Solution to Problem

According to an embodiment of the present invention, a method for producing a turbine blade includes performing brazing treatment, performing annealing, and subjecting a base material to solutionizing treatment. In the brazing treatment, a brazing material is welded to be joined to the base material of a turbine blade by operating a heater to perform heating at a first temperature under a state in which the base material having the brazing material arranged thereon is placed in a predetermined heating furnace including the heater. In the annealing, the base material is cooled by stopping the heater and lowering a furnace internal temperature after the brazing treatment. In the solutionizing treatment, the base material is heated at a second temperature lower than the first temperature after the annealing.

According to an embodiment of the present invention, after the brazing treatment is performed, the base material is cooled through the annealing. Thus, a formation of a void or the like in a brazing portion can be suppressed. With this, quality of the brazing portion can be improved. Further, the base material is cooled through the annealing, the γ′ phase to be precipitated can sufficiently be increased, and the γ′ phase can be prevented to be increased excessively. With this, strength and ductility of the base material can be prevented from being degraded.

Further, the method for producing a turbine blade may further include forming first coating and forming second coating. The first coating is formed through use of a metallic material having a higher wear-resisting property than that of the base material, and is formed on a portion of the base material corresponding to a contact surface of the turbine blade. The second coating is formed through use of a metallic material having a higher oxidation-resisting property than that of the base material, and is formed on a surface of the base material. The brazing treatment may be performed after the first coating and the second coating are formed.

According to an embodiment of the present invention, through the brazing treatment and the solutionizing treatment, atoms forming the first coating and the second coating are diffused. Thus, the brazing treatment and the solutionizing treatment can be performed as the diffusing treatment, with which adhesiveness is improved. With this, efficiency of the heating treatment can be improved.

Further, the method for producing a turbine blade may further include performing quenching for cooling the base material by supplying a cooling air into the heating furnace after the furnace internal temperature reaches a predetermined temperature through the annealing. The solutionizing treatment may be performed after the quenching.

According to an embodiment of the present invention, the quenching is performed under a state a formation of a void or the like is suppressed through the annealing. Thus, quality of the brazing portion can be maintained, and a cooling time period can be shortened.

Further, the method for producing a turbine blade may further include forming first coating, forming second coating, and performing quenching. The first coating is formed through use of a metallic material having a higher wear-resisting property than that of the base material, and is formed on a portion of the base material corresponding to a contact surface of the turbine blade. The second coating is formed through use of a metallic material having a higher oxidation-resisting property than that of the base material, and is formed on a surface of the base material. The quenching is performed to cool the base material by supplying a cooling air into the heating furnace after the furnace internal temperature reaches a predetermined temperature through the annealing. The first coating and the second coating may be formed after the brazing treatment, the annealing, and the quenching are performed. The solutionizing treatment may be performed after the first coating and the second coating are formed.

According to an embodiment of the present invention, after the brazing treatment is performed, the base material is cooled through the annealing, and then is subjected to the solutionizing treatment. Thus, a formation of a void or the like in a brazing portion can be suppressed. With this, quality of the brazing portion can be improved. Further, after a predetermined temperature is reached after the annealing, the cooling treatment is performed for a short time period through the quenching.

Further, the method for producing a turbine blade may further include forming an undercoat and a topcoat. The undercoat is formed on a surface of the base material as the second coating, and the topcoat is formed on a surface of the undercoat after the undercoat is formed. The topcoat may be formed after the brazing treatment and the solutionizing treatment are performed.

According to an embodiment of the present invention, after the undercoat is formed and before the topcoat is formed, the brazing treatment and the solutionizing treatment are performed. Thus, the heating treatment can efficiently be performed in a short time period, and a crack in the topcoat can be suppressed.

Further, the undercoat may be formed after the brazing treatment and the solutionizing treatment are performed.

According to an embodiment of the present invention, the undercoat is formed after the brazing treatment and the solutionizing treatment are performed. After that, the topcoat is formed. As described above, other processes such as the heating treatment are not performed from the formation of the undercoat to the formation of the topcoat. Accordingly, foreign substances and the like are prevented from adhering to the surface of the undercoat. When the foreign substances and the like adhere to the surface, an anchoring effect of the undercoat is degraded. As a countermeasure, in this modified example, the foreign substances and the like are prevented from adhering to prevent degradation of the anchoring effect. With this, degradation of adhesiveness between the undercoat and the topcoat can be prevented.

Further, the method for producing a turbine blade may further include performing aging treatment by heating the base material after the solutionizing treatment. The topcoat may be formed after the aging treatment.

According to an embodiment of the present invention, formation of a spot, a crack, or the like in the topcoat can be suppressed when the topcoat is formed, and quality of the brazing portion can be improved.

Further, the method for producing a turbine blade may further include performing adjusting treatment for causing the furnace internal temperature to rise to the second temperature by operating the heater after the furnace internal temperature reaches a third temperature lower than the second temperature through the annealing.

According to an embodiment of the present invention, the heating treatment in which the first temperature is changed to the third temperature via the second temperature can efficiently be performed.

Further, the method for producing a turbine blade may further include performing the aging treatment and forming the topcoat. In the aging treatment, the base material is heated after the solutionizing treatment. The topcoat is formed on the surface of the second coating after the aging treatment.

According to an embodiment of the present invention, formation of a spot, a crack, or the like in the topcoat can be suppressed when the topcoat is formed, and quality of the brazing portion can be improved.

Further, in the annealing, the temperature of the base material may be lowered at a temperature lowering rate of from 3° C./min to 20° C./min.

According to an embodiment of the present invention, in the annealing, the temperature of the base material is lowered at a temperature lowering rate equal to or greater than 3° C./min. Thus, degradation of strength of the base material can be suppressed, and increase in treatment time period can be suppressed. Further, the temperature of the base material is lowered at a temperature lowering rate equal to or less than 20° C./min. Thus, degradation of quality of the brazing portion can be suppressed, and degradation of ductility of the base material can be suppressed.

### Advantageous Effect of Invention

According to the present invention, the method for producing a turbine blade, which is capable of improving quality of the brazing portion, can be provided.

### BRIEF DESCRIPTION OF DRAWINGS

FIG. 1 is a flowchart for illustrating an example of a method for producing a turbine blade according to a first embodiment of the present invention.

FIG. 2 is a graph for showing an example of a time change of a heating temperature in a case where brazing treatment and solutionizing treatment are sequentially performed.

FIG. 3 is a flowchart for illustrating an example of a method for producing a turbine blade according to a second embodiment of the present invention.

FIG. 4 is a graph for showing an example of a time change of a heating temperature in the brazing treatment.

FIG. 5 is a flowchart for illustrating an example of a method for producing a turbine blade according to a modified example of the present invention.

FIG. 6 is a flowchart for illustrating an example of a method for producing a turbine blade according to a modified example of the present invention.

FIG. 7 is a microphotographic view for showing a precipitation state of a γ′ phase of a base material of a turbine blade in Comparative Example 1.

FIG. 8 is a microphotographic view for showing a precipitation state of a γ′ phase of a base material of a turbine blade in Comparative Example 2.

FIG. 9 is a microphotographic view for showing a precipitation state of a γ′ phase of a base material of a turbine blade in Example.

FIG. 10 is a microphotographic view for showing a brazing portion and the vicinity of the brazing portion of the base material of the turbine blade in Comparative Example 2.

FIG. 11 is an enlarged microphotographic view for showing the brazing portion of the base material of the turbine blade in Comparative Example 2.

FIG. 12 is a microphotographic view for showing a brazing portion and the vicinity of the brazing portion of the base material of the turbine blade in Example.

### DESCRIPTION OF EMBODIMENTS

Now, with reference to the drawings, description is made of a method for producing a turbine blade according to embodiments of the present invention. Note that, the invention is not limited to the embodiments. Further, the constituent elements in the following embodiments include those that can be easily replaced by a person skilled in the art or those that are substantially the same.

### First Embodiment

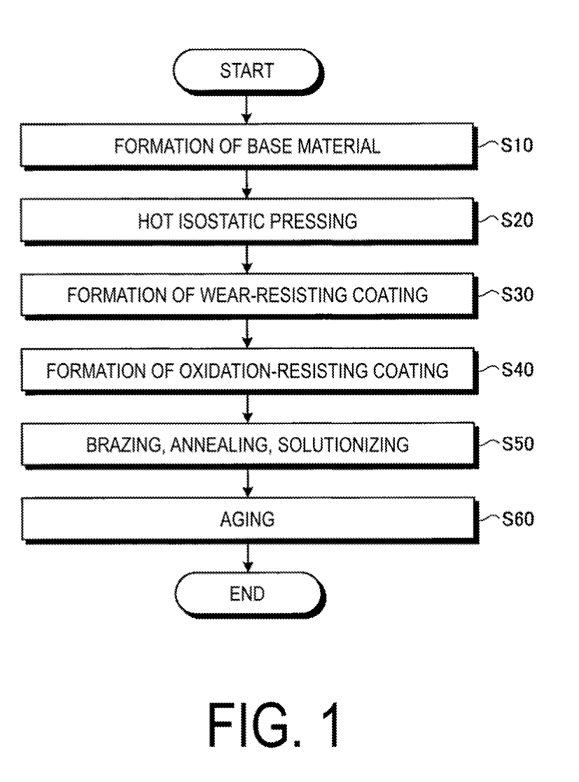

FIG. 1 is a flowchart for illustrating an example of a method for producing a turbine blade according to a first embodiment of the present invention. As illustrated in FIG. 1, the method for producing a turbine blade according to the first embodiment includes, for example, a step of forming a base material of a turbine blade such as a stator blade and a rotor blade of a gas turbine (Step S10), a step of subjecting the base material to hot isostatic pressing treatment (Step S20), a step of forming wear-resisting coating (first coating) on a surface of the base material (Step S30), a step of forming oxidation-resisting coating (second coating) on the surface of the base material and the wear-resisting coating (Step S40), a step of subjecting the base material to brazing treatment and solutionizing treatment (Step S50), and a step of subjecting the base material to aging treatment (Step S60).

In Step S10, the base material forming a turbine blade such as a stator blade and a rotor blade is formed. As the turbine blades described above, for example, rotor blades with a shroud are exemplified. A plurality of rotor blades with a shroud are arrayed in a predetermined direction, for example, in a rotation direction of a rotor of the turbine, and each have a contact surface.

The turbine blades are exposed in a high temperature environment in the gas turbine. Thus, the base material forming a turbine blade is formed of an alloy having a high heat-resisting property, for example, a Ni-based alloy. As the Ni-based alloy, for example, there is exemplified a Ni-based alloy containing: from 12.0% to 14.3% of Cr; from 8.5% to 11.0% of Co; from 1.0% to 3.5% of Mo; from 3.5° A to 6.2% of W; from 3.0% to 5.5% of Ta; from 3.5° A to 4.5% of Al; from 2.0% to 3.2% of Ti; from 0.04° A to 0.12% of C; from 0.005% to 0.05% of B; and the remnant of Ni and inevitable impurities. Further, the Ni-based alloy with the above-mentioned composition may contain from 0.001 ppm to 5 ppm of Zr. Further, the Ni-based alloy with the above-mentioned composition may contain from 1 ppm to 100 ppm of Mg and/or Ca, and further may contain one or more of the following: from 0.02% to 0.5% of Pt; from 0.02° A to 0.5% of Rh; and from 0.02° A to 0.5% of Re. The Ni-based alloy with the above-mentioned composition may satisfy both of those conditions.

The base material is formed of the above-mentioned material through casting, forging, and the like. When the base material is formed through casting, the base material such as a conventional casting (CC) material, a directional solidification (DS) material, and a single crystal (SC) material can be formed. Now, description is made of a case where a conventional casting material is used as the base material, but the present invention is not limited thereto. The base material may be a directional solidification material or a single crystal material.

In the hot isostatic pressing (HIP) treatment in Step S20, the base material is heated at a temperature of, for example, from 1180° C. to 1220° C. under a state of being placed in an argon gas atmosphere. With this, heating is performed under a state in which an entire surface of the base material is equally pressurized. After the hot isostatic pressing treatment is completed, the temperature of the base material is lowered by stopping the heating (annealing). Note that, after Step S20, treatment similar to the solutionizing treatment to be described later may be performed.

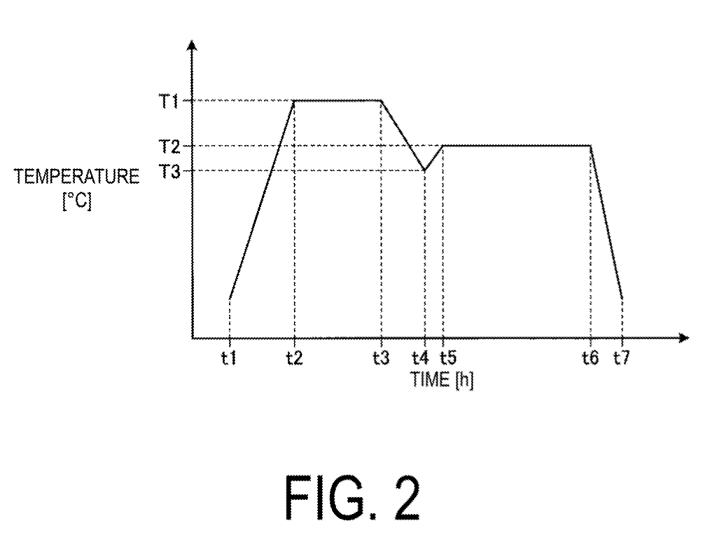

In Step S30, the wear-resisting coating (first coating) is formed on, for example, a portion of the base material corresponding to a contact surface 3 of a rotor blade 1 shown in FIG. 2. As the wear-resisting coating, for example, a cobalt-based wear-resisting material such as Tribaloy (trade name) 800 may be used. In Step S30, a layer formed of the above-mentioned material may be formed on the portion of the base material corresponding to the contact surface 3 with a method such as atmospheric plasma spraying, high-velocity flame spraying, low-pressure plasma spraying, and atmospheric plasma spraying.

In Step S40, the oxidation-resisting coating (second coating) is formed on the surface of the base material. As a material of the oxidation-resisting coating, for example, an alloy material such as MCrAlY having a higher oxidation-resisting property than that of the base material may be used. In Step S40, for example, after the surface of the base material is heated, the above-mentioned alloy material or the like is thermally sprayed against the surface of the base material. In this manner, the oxidation-resisting coating is formed.

In Step S50, the base material is subjected to the brazing treatment, and annealed. Then, the base material is subjected to the solutionizing treatment. In the brazing treatment, the base material having a brazing material arranged thereon is heated, and the brazing material is welded and joined to the base material. As the brazing material, for example, a material such as Amdry (trade name) DF-6A is used. In this case, the liquidus temperature of the brazing material is, for example, approximately 1155° C. An amount of the brazing material to be used for the brazing treatment is adjusted in advance by performing tests and the like. In the brazing treatment, the heating treatment can be performed at a first temperature (T1) at which the brazing material can be welded, for example, at a temperature of from 1175° C. to 1215° C.

In the solutionizing treatment, the base material is heated so that the γ′ phase being an intermetallic compound in the base material is solutionized and increased. In the solutionizing treatment, for example, the heating treatment can be performed at a second temperature (T2) lower than the heating temperature in the brazing treatment, for example, at a temperature of from 1100° C. to 1140° C.

FIG. 2 is a graph for showing an example of a time change of a heating temperature in the heating treatment in Step S50. In FIG. 2, a horizontal axis indicates time, and a vertical axis indicates a temperature. In Step S50, first, the brazing treatment is performed. In the brazing treatment, the base material having a brazing material arranged thereon is placed in a predetermined heating furnace, a heater of the heating furnace is operated to start heating (time ti). When the furnace internal temperature (heating temperature) in the heating furnace reaches the above-mentioned first temperature T1 (time t2), the rise of the furnace internal temperature is stopped, and the heating treatment is performed at the first temperature T1 for a predetermined time period. With this, the brazing material is welded and joined to the base material.

Note that, after the base material is placed in the heating furnace, the furnace internal temperature may be caused to rise to a predetermined preheating temperature, and the heating treatment (preheating treatment) may be performed at the preheating temperature for a predetermined time period. The preheating temperature in this case is set to a temperature lower than the liquidus temperature of the brazing material, and may be, for example, 1100° C. With the preheating treatment, the temperatures of the base material and the brazing material rises uniformly in an entire area, and a temperature difference among the portions is reduced. When the preheating treatment is performed for a predetermined time period, the furnace internal temperature is caused to rise to the first temperature T1 after the preheating treatment, and then the brazing treatment is performed.

After the brazing treatment is performed for a predetermined time period (time t3), the temperature of the base material is lowered to a third temperature T3 lower than the second temperature T2 in the solutionizing treatment at a temperature lowering rate approximately from 3° C./min to 20° C./min (annealing) by, for example, stopping the heater. Note that, annealing may be performed by, for example, supplying a cooling air into the heating furnace and adjusting the temperature lowering rate. The third temperature T3 may be a temperature of, for example, from 980° C. to 1020° C. Through annealing for cooling the base material, a formation of a void in a brazing portion is suppressed.

After the furnace internal temperature reaches the third temperature T3 through annealing, adjusting treatment for causing the furnace internal temperature to rise is performed (time t4). In the adjusting treatment, the heater is operated so that the furnace internal temperature is caused to rise to the second temperature T2. When the furnace internal temperature rises to the second temperature T2 (time t5), the rise of the furnace internal temperature is stopped, and the solutionizing treatment is performed at the second temperature T2 in the heating furnace. After the solutionizing treatment is performed for a predetermined time period, for example, the heater is stopped, and a cooling air is supplied into the heating furnace (time t6). By supplying a cooling air, the temperature of the base material is rapidly lowered to a predetermined cooling temperature at a temperature lowering rate of, for example, approximately 30° C./min (quenching). With the quenching treatment, the state of the γ′ phase (particle diameter and the like) is maintained. After the furnace internal temperature becomes a predetermined temperature (time t7), the base material is taken out from the heating furnace. Then, Step S50 is completed.

Note that, through the heating treatment in Step S50, the wear-resisting coating and the oxidation-resisting coating are diffused on the surface of the base material. Accordingly, adhesiveness between the surface of the base material and each coating is improved.

In the aging treatment in Step S60, the base material having been subjected to the solutionizing treatment is heated. Then, the γ′ phase increased in the base material in the solutionizing treatment is further increased, and at the same time, the γ′ phase having a smaller diameter than that of the γ′ phase generated in the solutionizing treatment is precipitated. The γ′ phase having a smaller diameter increases strength of the base material. Thus, in the aging treatment, the γ′ phase having a smaller diameter is precipitated to increase the strength of the base material. As a result, the strength and ductility of the base material are adjusted. In the aging treatment, for example, a temperature may be set from 830° C. to 870° C. After the aging treatment is performed for a predetermined time period, the temperature of the base material is lowered rapidly to a predetermined cooling temperature at a temperature lowering rate of, for example, approximately 30° C./min (quenching) by, for example, stopping the heater of the heating furnace and supplying a cooling air into the heating furnace.

As described above, in the method for producing a turbine blade according to the first embodiment, after the brazing treatment is performed, the base material is cooled through annealing, and then the solutionizing treatment is performed. Thus, a formation of a void and the like in the brazing portion can be suppressed. With this, quality of the brazing portion can be improved. Further, in the method for producing a turbine blade according to the first embodiment, the brazing treatment and the solutionizing treatment are sequentially performed. Thus, a time period of the heating treatment can be shortened, and the steps in the heating treatment can be simplified.

### Second Embodiment

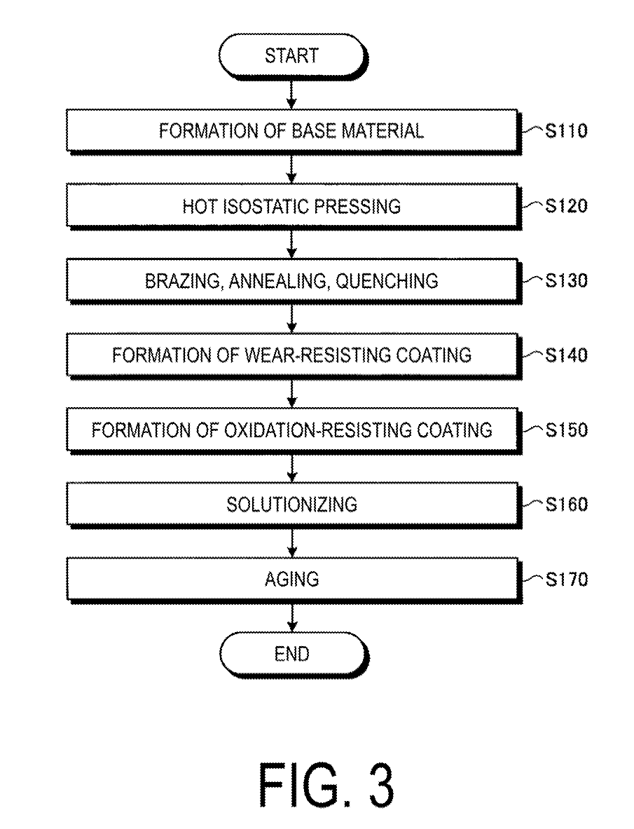

FIG. 3 is a flowchart for illustrating an example of diffusing treatment in a method for producing a turbine blade according to a second embodiment of the present invention. In the method for producing a turbine blade according to the second embodiment, an order of the brazing treatment is different from that in the first embodiment.

As illustrated in FIG. 3, the method for producing a turbine blade according to the second embodiment includes a step of forming the base material of a turbine blade (Step S110), a step of subjecting the base material to the hot isostatic pressing treatment (Step S120), a step of subjecting the base material to the brazing treatment (Step S130), a step of forming the wear-resisting coating (first coating) on the surface of the base material (Step S140), a step of forming the oxidation-resisting coating (second coating) on the surface of the base material and the wear-resisting coating (Step S150), a step of subjecting the base material to the solutionizing treatment (Step S160), and a step of subjecting the base material to the aging treatment (Step S170). Step S110 and Step S120 are the same as Step S10 and Step S20 in the first embodiment, and hence description therefor is omitted.

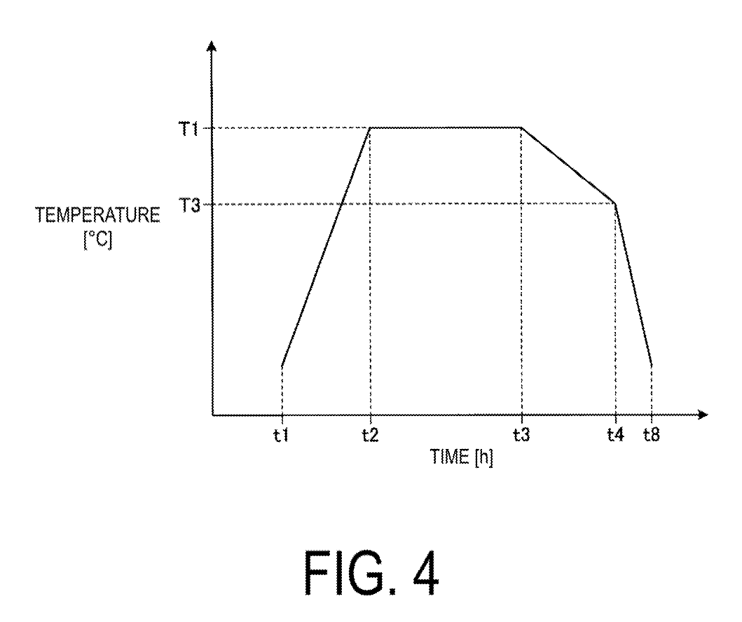

FIG. 4 is a graph for showing an example of a time change of a heating temperature in the heating treatment in Step S130. In FIG. 4, a horizontal axis indicates time, and a vertical axis indicates a temperature. In Step S130, the same treatment as the brazing treatment and annealing in the first embodiment is performed (from time t1 to time t3). Through annealing for cooling the base material, a formation of a void in a brazing portion is suppressed. After that, when the temperature of the base material reaches, for example, the third temperature T3 (for example, a temperature of from 980° C. to 1020° C.), the temperature of the base material is lowered rapidly at a temperature lowering rate of, for example, approximately 30° C./min (quenching) by supplying a cooling air into the heating furnace. Through quenching, the cooling treatment is performed for a short time period. After the furnace internal temperature becomes a predetermined temperature (time t8), the base material is taken out from the heating furnace. Then, Step S130 is completed.

After that, in Step S140 and Step S150, the treatment similar to that in Step S30 and Step S40 in the first embodiment is performed.

In Step S160, the base material having the oxidation-resisting coating formed thereon is placed in a predetermined heating furnace, and then the solutionizing treatment is performed at the second temperature T2 (for example, a temperature of from 1100° C. to 1140° C.) similarly to the first embodiment. In the solutionizing treatment, the base material is heated so that the γ′ phase is solutionized and increased. Further, the wear-resisting coating and the oxidation-resisting coating are diffused on the surface of the base material. Accordingly, adhesiveness between the surface of the base material and each coating is improved. After the solutionizing treatment, the temperature of the base material is lowered rapidly at a temperature lowering rate of, for example, approximately 30° C./min (quenching) by, for example, stopping the heater of the heating furnace and supplying a cooling air into the heating furnace.

In Step S170, the treatment similar to that in Step S60 in the first embodiment is performed.

As described above, in the method for producing a turbine blade according to the first embodiment, after the brazing treatment is performed, the base material is cooled through annealing, and then the solutionizing treatment is performed. Thus, a formation of a void and the like in the brazing portion can be suppressed. With this, quality of the brazing portion can be improved. Further, after a predetermined temperature (for example, the third temperature T3) is reached after annealing, the cooling treatment is performed for a short time period through quenching.

The technical scope of the present invention is not limited to the above-mentioned embodiments, and can be changed as appropriate without departing from the scope of the present invention. For example, in the above-mentioned embodiment, description is made of a case where a topcoat is not formed, but the present invention is not limited thereto. The present invention is applicable to a case where a topcoat is formed.

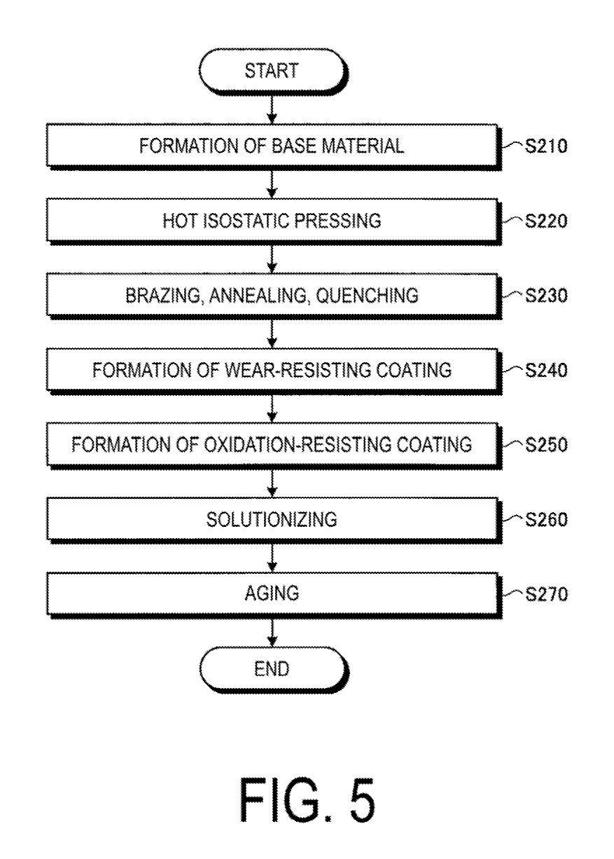

FIG. 5 is a flowchart for illustrating an example of a method for producing a turbine blade according to a modified example of the present invention. As illustrated in FIG. 5, the method for producing a turbine blade according to the modified example includes a step of forming the base material through use of a conventional casting material (Step S210), a step of subjecting the base material to the hot isostatic pressing treatment (Step S220), a step of forming the wear-resisting coating on the surface of the base material (Step S230), a step of forming an undercoat on the surface of the base material and the wear-resisting coating (Step S240), a step of subjecting the base material to the brazing treatment and the solutionizing treatment (Step S250), a step of subjecting the base material to the aging treatment (Step S260), and a step of forming a topcoat on the base material (Step S270). Step S210 to Step S230 are the same as Step S10 and Step S20 in the first embodiment, and hence description therefor is omitted.

In Step S240, the undercoat is formed on the surface of the base material.

The undercoat is a part of thermal barrier coating (TBC) for protecting the turbine blade from a high temperature. The undercoat prevents oxidation of the base material, and improves adhesiveness of the topcoat. As a material of the undercoat, for example, an alloy material such as MCrAlY having a higher oxidation-resisting property than that of the base material may be used. In Step S240, for example, after the surface of the base material is heated, the above-mentioned alloy material or the like is thermally sprayed against the surface of the base material. In this manner, the undercoat is formed. Note that, before the undercoat is formed on the surface of the base material, for example, alumina (Al₂O₃) may be sprayed against the surface of the base material so as to roughen the surface of the base material. With this, adhesiveness between the base material and the undercoat is improved with an anchoring effect. Note that, after the blasting treatment, cleaning treatment for cleaning the surface of the base material may be performed.

After that, in Step S250 and Step S260, the treatment similar to that in Step S250 and Step S260 in the first embodiment is performed. The heating treatment in Step S250 and Step S260 is performed. Accordingly, the undercoat is diffused on the roughened surface of the base material, and adhesiveness between the surface of the base material and the undercoat is improved.

In Step S270, the topcoat is formed on the surface of the undercoat. The topcoat is a part of the above-mentioned thermal barrier coating, and protects the surface of the base material from a high temperature. As a material of the topcoat, a material having a small thermal conductivity such as ceramics is used. As ceramics, a material containing, for example, zirconia as a main component is used. In Step S270, the topcoat is formed by, for example, applying the above-mentioned material to the surface of the undercoat through atmospheric plasma spraying.

In the above-mentioned method for producing a turbine blade, the brazing treatment, the solutionizing treatment, and the aging treatment are performed before the topcoat is formed on the base material. Thus, formation of a spot, a crack, or the like in the topcoat can be suppressed. With this, formation of a spot, a crack, or the like in the thermal barrier coating can be suppressed, and quality of the brazing portion is improved.

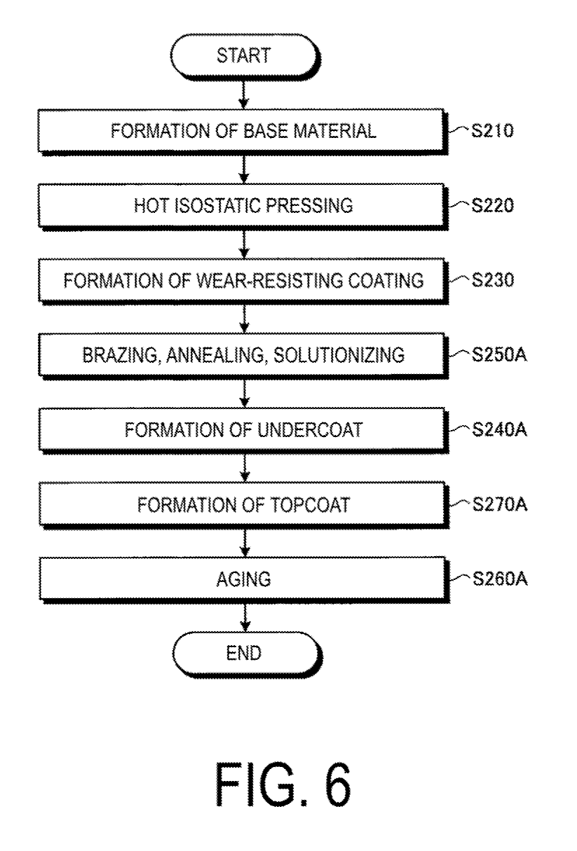

Further, in the example of FIG. 5, description is made of a case where the brazing treatment and the solutionizing treatment are performed after the undercoat is formed, but the present invention is not limited thereto. FIG. 6 is a flowchart for illustrating an example of a method for producing a turbine blade according to a modified example of the present invention. As illustrated in FIG. 6, in the method for producing a turbine blade according to the modified example, Step S210 to Step S230 are the same as those in the example illustrated in FIG. 5. However, the example illustrated in FIG. 6 is different from the example illustrated in FIG. 5 in that the brazing treatment and the solutionizing treatment are performed after Step S230 (Step S250A) and the undercoat is formed after the brazing treatment and the solutionizing treatment (Step S240A). After the undercoat is formed, the topcoat is formed while the heating treatment is not performed (Step S270A). Further, after the topcoat is formed, similarly to the example illustrated in FIG. 5, the aging treatment is performed (Step S260A).

As illustrated in the example illustrated in FIG. 6, after the undercoat is formed and before the topcoat is formed, other processes such as the heating treatment are not performed. Accordingly, adhesion of foreign matter and the like on the surface of the undercoat can be suppressed. When foreign substances and the like adhere to the surface, an anchoring effect of the undercoat is degraded. As a countermeasure, in this modified example, the foreign substances and the like are prevented from adhering to prevent degradation of the anchoring effect. With this, degradation of adhesiveness between the undercoat and the topcoat can be prevented.

### Examples

Next, description is made of Examples of the present invention. In Examples, a plurality of base materials are formed through casting from a Ni-based alloy with the composition described in the above-mentioned embodiments. The plurality of base materials are formed as conventional casting materials (CC materials). The base material in Example is obtained in the following manner. That is, the base material among the plurality of base materials is sequentially subjected to the brazing treatment and the solutionizing treatment under the temperature change shown in FIG. 2 in the first embodiment. In Example, the first temperature T1 is set to 1195° C., the second temperature T2 is set to 1120° C., and the third temperature T3 is set to 1000° C. Further, the aging treatment is performed at 850° C.

Further, the base material in Comparative Example 1 is obtained in the following manner. That is, the base material among the plurality of base materials is subjected to the hot isostatic pressing treatment, and then subjected to the solutionizing treatment without performing the brazing treatment. After each coating is formed, the aging treatment is performed. In Comparative Examples, the solutionizing treatment is performed at 1120° C. Further, the aging treatment is performed at 850° C. Each time after the solutionizing treatment and the aging treatment, quenching is performed.

Further, the base material in Comparative Example 2 is obtained in the following manner. That is, the base material among the plurality of base materials is subjected to the hot isostatic pressing treatment (and the solutionizing treatment), and then subjected to the brazing treatment. After that, the solutionizing treatment and the aging treatment are performed. In Comparative Example 2, the brazing treatment is performed at 1195° C., the solutionizing treatment is performed at 1120° C., and the aging treatment is performed at 850° C. Further, each time after the brazing treatment, the solutionizing treatment, and the aging treatment, quenching is performed.

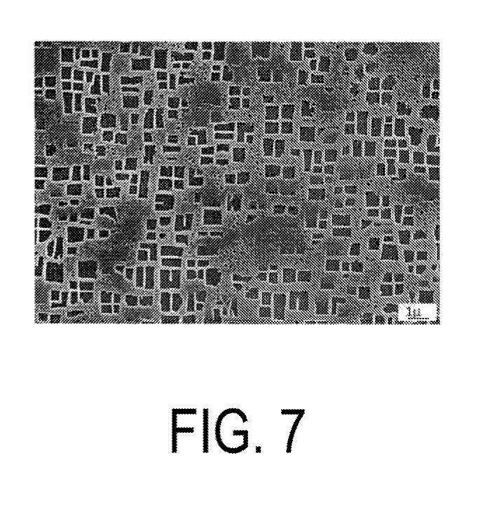

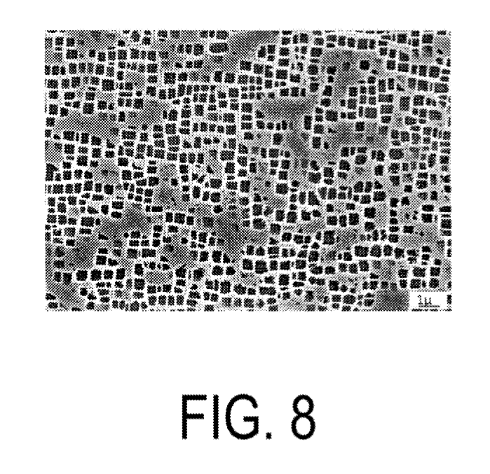

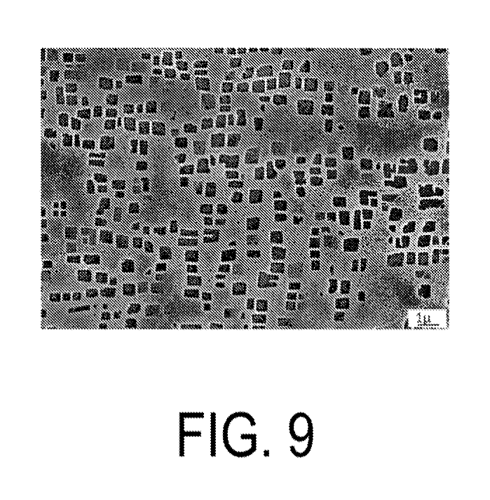

FIG. 7 is a microphotographic view for showing a precipitation state of a γ′ phase of a base material of a turbine blade in Comparative Example 1. FIG. 8 is a microphotographic view for showing a precipitation state of a γ′ phase of a base material of a turbine blade in Comparative Example 2. FIG. 9 is a microphotographic view for showing a precipitation state of a γ′ phase of a base material of a turbine blade in Example.

As shown in FIG. 7, in the base material in Comparative Example 1, the γ′ phase increased in the solutionizing treatment and the γ′ phase having a small diameter precipitated in the aging treatment are present in well-balanced manner. In contrast, as compared to the base material in Comparative Example 1, in the base material in Comparative Example 2 as shown in FIG. 8, the γ′ phase increased in the solutionizing treatment has a small diameter, and ductility of the base material is not sufficiently secured. Note that, the γ′ phase is precipitated and increased while cooling in the brazing treatment. However, in Comparative Example 2, quenching is performed in the brazing treatment. Accordingly, the γ′ phase is not sufficiently increased, and has a smaller diameter.

Meanwhile, similarly to Comparative Example 1, the base material in Example as shown in FIG. 9, the γ′ phase precipitated and increased in the solutionizing treatment and the γ′ phase having a small diameter precipitated in the aging treatment are present in a well-balanced manner. In Example 1, annealing is performed in the brazing treatment, which is similar to the cooling after the hot isostatic pressing treatment in Comparative Example 1. Therefore, the γ′ phases are present in a well-balanced manner similarly to Comparative Example 1.

Therefore, according to Example, after the brazing treatment, the base material is annealed, and hence quality of the brazing portion can be improved. In addition, the γ′ phase, which is precipitated through annealing after the brazing treatment and increased in the solutionizing treatment, and the γ′ phase having a small diameter precipitated in the aging treatment are present in a well-balanced manner.

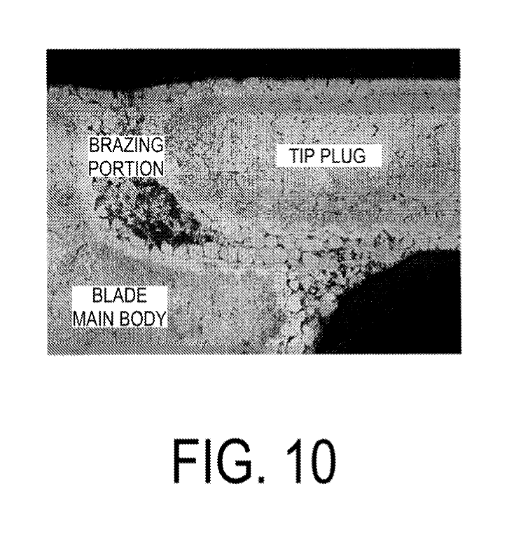

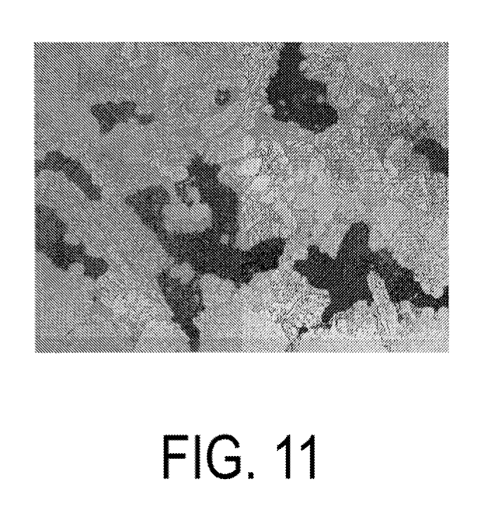

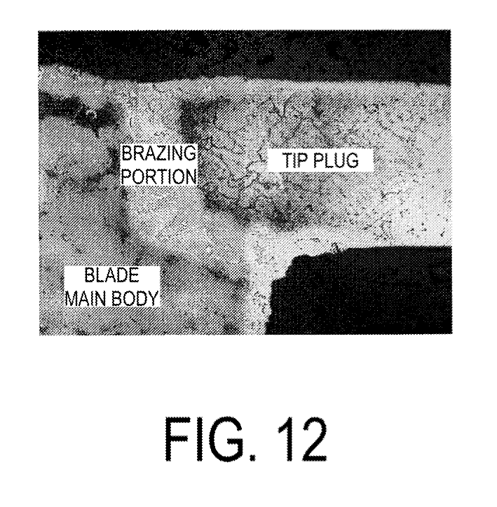

FIG. 10 is a microphotographic view for showing a brazing portion and the vicinity of the brazing portion of the base material of the turbine blade in Comparative Example 2. FIG. 11 is an enlarged microphotographic view for showing the brazing portion of the base material of the turbine blade in Comparative Example 2. FIG. 12 is a microphotographic view for showing a brazing portion and the vicinity of the brazing portion of the base material of the turbine blade in Example.

As shown in FIG. 10 and FIG. 11, a number of voids are formed in the brazing portion of the base material of the turbine blade in Comparative Example 2. In contrast, as shown in FIG. 12, a void is hardly observed in the brazing portion of the base material of the turbine blade in Example. As described above, in Example, quality of the brazing portion can be improved.

### REFERENCE SIGNS LIST

1 Rotor blade

2 Shroud

3 Contact surface

T1 First temperature

T2 Second temperature

T3 Third temperature

1. A method for producing a turbine blade, comprising:
performing brazing treatment for welding a brazing material to be joined to a base material of a turbine blade by operating a heater to perform heating at a first temperature under a state in which the base material having the brazing material arranged thereon is placed in a predetermined heating furnace including the heater;
performing annealing for cooling the base material by stopping the heater and lowering a furnace internal temperature after the brazing treatment; and
subjecting the base material to solutionizing treatment by heating the base material at a second temperature lower than the first temperature after the annealing.

2. The method for producing a turbine blade according to claim 1, further comprising:
forming first coating through use of a metallic material having a higher wear-resisting property than a wear-resisting property of the base material, the first coating formed on a portion of the base material corresponding to a contact surface of the turbine blade; and
forming second coating through use of a metallic material having a higher oxidation-resisting property than an oxidation-resisting property of the base material, the second coating formed on a surface of the base material,
wherein the brazing treatment is performed after the first coating and the second coating are formed.

3. The method for producing a turbine blade according to claim 1, further comprising performing quenching for cooling the base material by supplying a cooling air into the heating furnace after the furnace internal temperature reaches to a predetermined temperature through the annealing,
wherein the solutionizing treatment is performed after the quenching.

4. The method for producing a turbine blade according to claim 1, further comprising:
forming first coating through use of a metallic material having a higher wear-resisting property than a wear-resisting property of the base material, the first coating formed on a portion of the base material corresponding to a contact surface of the turbine blade;
forming second coating through use of a metallic material having a higher oxidation-resisting property than an oxidation-resisting property of the base material, the second coating formed on a surface of the base material; and
performing quenching for cooling the base material by supplying a cooling air into the heating furnace after the furnace internal temperature reaches a predetermined temperature through the annealing,
wherein the first coating and the second coating are formed after the brazing treatment, the annealing, and the quenching are performed, and
wherein the solutionizing treatment is performed after the first coating and the second coating are formed.

5. The method for producing a turbine blade according to claim 2, further comprising:
forming an undercoat on a surface of the base material as the second coating; and
forming a topcoat on a surface of the undercoat after the undercoat is formed,
wherein the topcoat is formed after the brazing treatment and the solutionizing treatment are performed.

6. The method for producing a turbine blade according to claim 2, wherein the undercoat is formed after the brazing treatment and the solutionizing treatment are performed.

7. The method for producing a turbine blade according to claim 2, further comprising performing aging treatment by heating the base material after the solutionizing treatment,
wherein the topcoat is formed after the aging treatment.

8. The method for producing a turbine blade according to claim 1, further comprising performing adjusting treatment for causing the furnace internal temperature to rise to the second temperature by operating the heater after the furnace internal temperature reaches a third temperature lower than the second temperature through the annealing.

9. The method for producing a turbine blade according to claim 1, wherein, in the annealing, a temperature of the base material is lowered at a temperature lowering rate of from 3° C./min to 20° C./min.
